(19) United States
(12) Patent Application Publication
(10) Pub. No.: US 2025/0007194 A1
(43) Pub. Date: Jan. 2, 2025

(54) FLOATING BOARD-TO-BOARD CONNECTOR

(71) Applicant: SHENZHEN GLOSHINE TECHNOLOGY CO., LTD., ShenZhen (CN)

(72) Inventors: Xianfeng ZHANG, ShenZhen (CN); Yongjun ZHANG, ShenZhen (CN); Guoqiang LI, ShenZhen (CN); Zhencheng HUANG, ShenZhen (CN); Xijian CHEN, ShenZhen (CN)

(73) Assignee: SHENZHEN GLOSHINE TECHNOLOGY CO., LTD., ShenZhen (CN)

(21) Appl. No.: 18/811,506

(22) Filed: Aug. 21, 2024

Related U.S. Application Data
(63) Continuation of application No. PCT/CN2024/100981, filed on Jun. 24, 2024.

(30) Foreign Application Priority Data
Jun. 29, 2023 (CN) 202321683213.X

(51) Int. Cl. H01R 12/91; H01R 12/71

(52) U.S. Cl. CPC H01R 12/91; H01R 12/716

(57) ABSTRACT

A floating board-to-board connector includes a male header and a female header. The female header includes a female header body and a plug-in member, the plug-in member is connected with the female header body, and the plug-in member is disposed through the female header body; the male header includes a male header body and a pin, the male header body is provided with a mounting cavity, the pin is connected in the mounting cavity, the mounting cavity is used for mounting the female header body, and the plug-in member is provided with a plug-in hole into which the pin is inserted; and a cavity wall of the mounting cavity is provided with a clamping groove, the female header further includes a clamping member, the clamping member is convexly arranged on the female header body, and the clamping groove is used for mounting the clamping member.

### CROSS-REFERENCE TO RELATED APPLICATIONS

This application is a continuation of International Application No. PCT/CN2024/100981, filed on Jun. 24, 2024, which claims priority to Chinese Patent Application No. 202321683213.X, filed on Jun. 29, 2023. All of the aforementioned applications are incorporated herein by reference in their entireties.

### TECHNICAL FIELD

The application relates to a floating board-to-board connector.

### BACKGROUND

The existing board-to-board connection device comprises a male header and a female header, the male header comprises a male header body and a pin, the male header body is provided with a mounting cavity, and the pin is provided through the mounting cavity. One end of the pin is the plug-in segment end, and the other end is used for electrical connection with the first electrical component. The female header comprises a female header body and a plug-in member, the female header body comprises a plug-in cavity, and the plug-in cavity is used for the male header body to be inserted. The plug-in member is arranged in the plug-in cavity, one end of the plug-in member is used for electrical connection with the second electrical component, and the other end of the plug-in member is provided with a plug-in hole. The plug-in hole is used for the plug-in end of the pin to be inserted when the male header body is inserted into the plug-in cavity, so as to electrically communicate the first electrical component and the second electrical component.

However, the male header and female header mentioned above are prone to misalign when they are connected, which makes it difficult for the pin to be inserted into the corresponding plug-in hole efficiently. This reduces insertion efficiency and may potentially cause damage to the pin or plug-in member.

### SUMMARY

Aiming at the problem that the male header and the female header of the existing board-to-board connection device are easily misaligned, the application provides a floating board-to-board connector.

To address the above technical problems, the present application provides a floating board-to-board connector, including a male header and a female header; wherein the female header includes a female header body and a plug-in member, the plug-in member is connected with the female header body, and the plug-in member is disposed through the female header body; the male header includes a male header body and a pin, the male header body is provided with a mounting cavity, the pin is connected in the mounting cavity, the mounting cavity is used for mounting the female header body, and the plug-in member is provided with a plug-in hole into which the pin is inserted; and a cavity wall of the mounting cavity is provided with a clamping groove, the female header further includes a clamping member, the clamping member is convexly arranged on the female header body, and the clamping groove is used for mounting the clamping member.

Optionally, the mounting cavity is rectangular, the cavity wall of the mounting cavity is provided with a first clamping groove in a length direction, and the cavity wall of the mounting cavity is provided with a second clamping groove in a width direction; and the female header body is rectangular, the clamping member includes a first clamping block and a second clamping block, the first clamping block is convexly arranged on a side wall of the female header body in the length direction, the first clamping block is used for being clamped into the first clamping groove, the second clamping block is convexly arranged on a side wall of the female header body in the width direction, and the second clamping block is used for being clamped into the second clamping groove.

Optionally, the first clamping grooves are arranged on two opposite cavity walls of the mounting cavity in the length direction, and the second clamping grooves are arranged on two opposite cavity walls of the mounting cavity in the width direction; the first clamping blocks are arranged on two opposite side walls of the female header body in the length direction, and the second clamping blocks are arranged on two opposite side walls of the female header body in the width direction.

Optionally, the oppositely arranged first clamping grooves are staggered, and the oppositely arranged first clamping blocks are staggered.

Optionally, the oppositely arranged second clamping grooves are symmetrical with respect to a centerline of the mounting cavity in the length direction, and the oppositely arranged second clamping blocks are symmetrical with respect to a centerline of the female header body in the length direction.

Optionally, an opening of the first clamping groove is provided with a first guide ramp, a bottom of the first clamping block is provided with a first mating ramp, and the first guide ramp is used to cooperate with the first mating ramp to guide the first clamping block to be mounted into the first clamping groove; and an opening of the second clamping groove is provided with a second guide ramp, and a bottom of the second clamping block is provided with a second mating ramp, the second guide ramp is used to cooperate with the second mating ramp to guide the second clamping block to be clamped into the second clamping groove.

Optionally, a cross-sectional area of the second clamping groove is larger than that of the first clamping groove, and a cross-sectional area of the second clamping block is larger than that of the first clamping block.

Optionally, a plurality of plug-in members and a plurality of pins are provided, and the plurality of pins are plugged into corresponding plug-in members in a one-to-one manner.

Optionally, the plug-in member includes two plug-in elastic sheets, the plug-in elastic sheet includes a plug-in part and a connecting part, one end of the connecting part extends out of the female header body for electrical connection with electrical components, another end of the connecting part is connected with the plug-in part, the plug-in part and the connecting part are obliquely arranged, and the two plug-in elastic sheets are oppositely arranged, so that the plug-in parts of the two plug-in elastic sheets are close to each other, and a gap between the two plug-in part forms the plug-in hole into which the pin is inserted.

Optionally, the plug-in part includes a plug-in body and a flaring, the plug-in body is connected with the connecting part, the flaring inclines towards the connecting part, the flaring is smoothly connected with the plug-in body, and the flaring is used for avoiding the pin.

According to the floating board-to-board connector of the embodiment of the present application, when the male header and the female header are connected, the first clamping block on the female header is correspondingly clamped into the first clamping groove, the second clamping block is correspondingly clamped in the second clamping groove. This can help align the female header body, allowing it to be fitted into the mounting cavity along the central axis of the male header body, thus preventing damage to the pin and plug-in member.

### BRIEF DESCRIPTION OF THE DRAWINGS

FIG. 1 is a structural schematic diagram of a female header provided by an embodiment of the present application.

FIG. 2 is a sectional view of FIG. 1.

FIG. 3 is a structural schematic diagram of a male header provided by an embodiment of the present application.

FIG. 4 is a sectional view of FIG. 3.

FIG. 5 shows the connection state of the male header and female header.

Reference signs in the drawings are as follows: 1. Female header; 2. Female header body; 3. Plug-in member; 4. First clamping block; 5. First mating ramp; 6. Second clamping block; 7. Second mating ramp; 8. Plug-in elastic sheet; 9. Connecting part; 10. Plug-in part; 11. Plug-in body; 12. Flaring; 13. Male header; 14. Male header body; 15. Pin; 16. Mounting cavity; 17. First clamping groove; 18. First guide ramp; 19. Second clamping groove; 20. Second guide ramp; 21. Clamping member.

### DETAILED DESCRIPTION OF THE EMBODIMENTS

In order to make the technical problems, technical solutions and beneficial effects of the present application more clear, the application will be further explained in detail below with reference to the drawings and embodiments. It should be understood that the specific embodiments described here are only used to illustrate the application, rather than to limit the application.

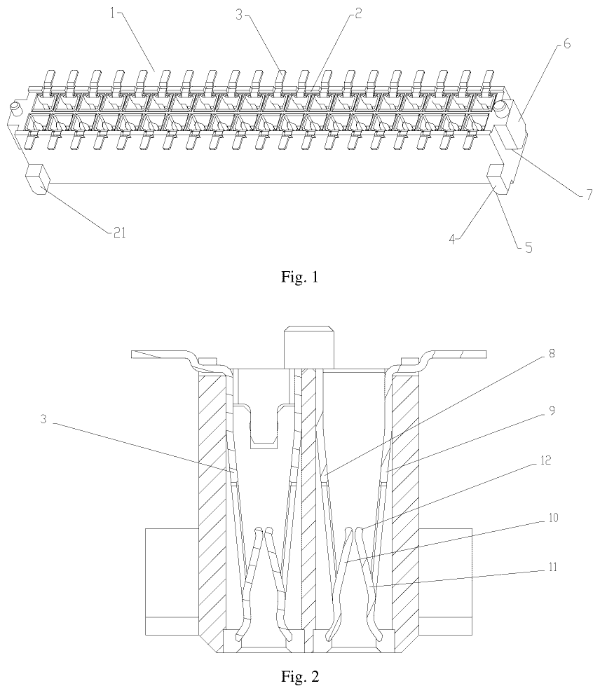

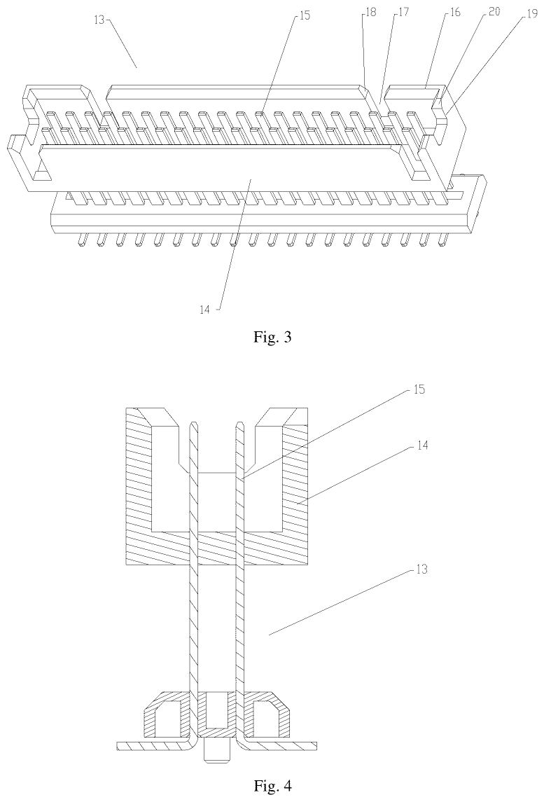

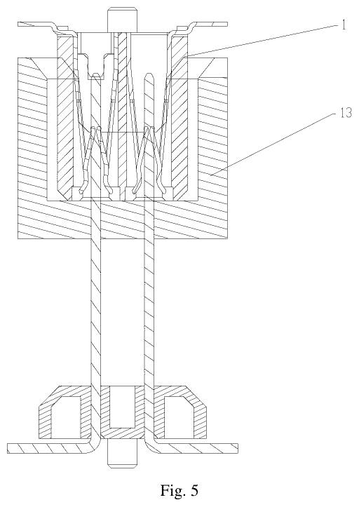

As shown in FIG. 1 to FIG. 5, an embodiment of the present application provides a floating board-to-board connector, which includes a male header 13 and a female header 1; the female header 1 includes a female header body 2 and a plug-in member 3, the plug-in member 3 is connected with the female header body 2, and the plug-in member 3 is disposed through the female header body 2; the male header 13 includes a male header body 14 and a pin 15, the male header body 14 is provided with a mounting cavity 16, the pin 15 is connected in the mounting cavity 16, the mounting cavity 16 is used for mounting the female header body 2, and the plug-in member 3 is provided with a plug-in hole into which the pin 15 is inserted.

A cavity wall of the mounting cavity 16 is provided with a clamping groove, the female header 1 further includes a clamping member 21, the clamping member 21 is convexly arranged on the female header body 2, and the clamping groove is used for mounting the clamping member 21.

In an embodiment, the mounting cavity 16 is rectangular, the cavity wall of the mounting cavity 16 is provided with a first clamping groove 17 in a length direction, and the cavity wall of the mounting cavity 16 is provided with a second clamping groove 19 in a width direction.

The female header body 2 is rectangular, the clamping member 21 includes a first clamping block 4 and a second clamping block 6, the first clamping block 4 is convexly arranged on a side wall of the female header body 2 in the length direction, the first clamping block 4 is used for being clamped into the first clamping groove 17, the second clamping block 6 is convexly arranged on a side wall of the female header body 2 in the width direction, and the second clamping block 6 is used for being clamped into the second clamping groove 19.

In an embodiment, the first clamping grooves 17 are arranged on two opposite cavity walls of the mounting cavity 16 in the length direction, and the second clamping grooves 19 are arranged on two opposite cavity walls of the mounting cavity 16 in the width direction; the first clamping blocks 4 are arranged on two opposite side walls of the female header body 2 in the length direction, and the second clamping blocks 6 are arranged on two opposite side walls of the female header body 2 in the width direction. The mounting cavity 16 and female header body 2 are designed as rectangles, which is convenient for manufacturing. The arrangement of the clamping grooves in the length direction and width direction can improve the stability of the female header body 2 when it is inserted in the mounting cavity 16.

In an embodiment, the first clamping grooves 17 are arranged on two opposite cavity walls of the mounting cavity 16 in the length direction, and the second clamping grooves 19 are arranged on two opposite cavity walls of the mounting cavity 16 in the width direction; the first clamping blocks 4 are arranged on two opposite side walls of the female header body 2 in the length direction, and the second clamping blocks 6 are arranged on two opposite side walls of the female header body 2 in the width direction. The two oppositely arrange clamping grooves can cooperate with the two oppositely arranged clamping blocks, so that the stability during insertion can be further improved.

In an embodiment, the oppositely arranged first clamping grooves 17 are staggered, and the oppositely arranged first clamping blocks 4 are staggered. The two first clamping grooves 17 are staggered, which is convenient for manufacturing.

In an embodiment, the oppositely arranged second clamping grooves 19 are symmetrical with respect to a centerline of the mounting cavity 16 in the length direction, and the oppositely arranged second clamping blocks 6 are symmetrical with respect to a centerline of the female header body 2 in the length direction. The two second clamping grooves 19 are symmetrically arranged, which is convenient for design.

In an embodiment, an opening of the first clamping groove 17 is provided with a first guide ramp 18, a bottom of the first clamping block 4 is provided with a first mating ramp 5, and the first guide ramp 18 is used to cooperate with the first mating ramp 5 to guide the first clamping block 4 to be mounted into the first clamping groove 17.

An opening of the second clamping groove 19 is provided with a second guide ramp 20, and a bottom of the second clamping block 6 is provided with a second mating ramp 7, the second guide ramp 20 is used to cooperate with the second mating ramp 7 to guide the second clamping block 6 to be clamped into the second clamping groove 19. The guide ramp is matched with the mating ramp, which can reduce the friction damage between the clamping groove and the clamping block.

In an embodiment, a cross-sectional area of the second clamping groove 19 is larger than that of the first clamping groove 17, and a cross-sectional area of the second clamping block 6 is larger than that of the first clamping block 4.

In an embodiment, a plurality of plug-in members 3 and a plurality of pins 15 are provided, and the plurality of pins 15 are plugged into corresponding plug-in members 3 in a one-to-one manner. The numbers of plug-in members 3 and pins 15 may be determined according to actual needs.

In an embodiment, the plug-in member 3 includes two plug-in elastic sheets 8, the plug-in elastic sheet 8 includes a plug-in part 10 and a connecting part 9, one end of the connecting part 9 extends out of the female header body 2 for electrical connection with electrical components, another end of the connecting part 9 is connected with the plug-in part 10, the plug-in part 10 and the connecting part 9 are obliquely arranged, and the two plug-in elastic sheets 8 are oppositely arranged, so that the plug-in parts 10 of the two plug-in elastic sheets 8 are close to each other, and a gap between the two plug-in part 10 forms the plug-in hole into which the pin 15 is inserted. The two plug-in elastic sheets 8 form a plug-in hole, which is convenient for manufacturing.

In an embodiment, the plug-in part 10 includes a plug-in body 11 and a flaring 12, the plug-in body 11 is connected with the connecting part 9, the flaring 12 inclines towards the connecting part 9, the flaring 12 is smoothly connected with the plug-in body 11, and the flaring 12 is used for avoiding the pin 15. The arrangement of flaring 12 can help avoid damage to the pin 15 during inserting.

The working principle of the floating board-to-board connector in the embodiment of the present application is as follows.

When in use, one end of the plug-in elastic sheet 8 extending out of the female header body 2 is connected with the first electrical component, and one end of the pin 15 extending out of the male header body 14 is connected with the second electrical component, and then the female header body 2 is mounted in the mounting cavity 16 of the male header body 14, so that the pin 15 is inserted into the plug-in hole. Thus, the first electrical component and the second electrical component are in conductive communication.

According to the floating board-to-board connector of the embodiment of the present application, when the male header 13 and the female header 1 are connected, the first clamping block 4 on the female header 1 is correspondingly clamped into the first clamping groove 17, the second clamping block 6 is correspondingly clamped in the second clamping groove 19. This can help align the female header body 2, allowing it to be fitted into the mounting cavity 16 along the central axis of the male header body 14, thus preventing damage to the pin 15 and plug-in member 3.

In other embodiments, the first clamping groove 17 is only provided on one cavity wall of the mounting cavity 16 in the length direction, and the first clamping block 4 is only provided on one side wall of the female header body 2 in the length direction.

In other embodiments, only the first clamping groove 17 and the first clamping block 4 are provided.

In other embodiments, two first clamping grooves 17 are symmetrical about the centerline of the mounting cavity 16 in the width direction, and two first clamping blocks 4 are symmetrical about the centerline of female header body 2 in the width direction.

The above are merely the preferred embodiments of this application, and are not intended to limit the application. Any modification, equivalent substitution and improvement made within the spirit and principle of this application shall be included in the protection scope of this application.

What is claimed is:

1. A floating board-to-board connector, comprising a male header and a female header; wherein the female header comprises a female header body and a plug-in member, the plug-in member is connected with the female header body, and the plug-in member is disposed through the female header body; the male header comprises a male header body and a pin, the male header body is provided with a mounting cavity, the pin is connected in the mounting cavity, the mounting cavity is used for mounting the female header body, and the plug-in member is provided with a plug-in hole into which the pin is inserted; and
a cavity wall of the mounting cavity is provided with a clamping groove, the female header further comprises a clamping member, the clamping member is convexly arranged on the female header body, and the clamping groove is used for mounting the clamping member.

2. The floating board-to-board connector of claim 1, wherein the mounting cavity is rectangular, the cavity wall of the mounting cavity is provided with a first clamping groove in a length direction, and the cavity wall of the mounting cavity is provided with a second clamping groove in a width direction; and
the female header body is rectangular, the clamping member comprises a first clamping block and a second clamping block, the first clamping block is convexly arranged on a side wall of the female header body in the length direction, the first clamping block is used for being clamped into the first clamping groove, the second clamping block is convexly arranged on a side wall of the female header body in the width direction, and the second clamping block is used for being clamped into the second clamping groove.

3. The floating board-to-board connector of claim 2, wherein the first clamping grooves are arranged on two opposite cavity walls of the mounting cavity in the length direction, and the second clamping grooves are arranged on two opposite cavity walls of the mounting cavity in the width direction; the first clamping blocks are arranged on two opposite side walls of the female header body in the length direction, and the second clamping blocks are arranged on two opposite side walls of the female header body in the width direction.

4. The floating board-to-board connector of claim 3, wherein the oppositely arranged first clamping grooves are staggered, and the oppositely arranged first clamping blocks are staggered.

5. The floating board-to-board connector of claim 3, wherein the oppositely arranged second clamping grooves are symmetrical with respect to a midline of the mounting cavity in the length direction, and the oppositely arranged second clamping blocks are symmetrical with respect to a midline of the female header body in the length direction.

6. The floating board-to-board connector of claim 2, wherein an opening of the first clamping groove is provided with a first guide ramp, a bottom of the first clamping block is provided with a first mating ramp, and the first guide ramp is used to cooperate with the first mating ramp to guide the first clamping block to be mounted into the first clamping groove; and
an opening of the second clamping groove is provided with a second guide ramp, and a bottom of the second clamping block is provided with a second mating ramp, the second guide ramp is used to cooperate with the second mating ramp to guide the second clamping block to be clamped into the second clamping groove.

7. The floating board-to-board connector of claim 2, wherein a cross-sectional area of the second clamping groove is larger than a cross-sectional area of the first clamping groove, and a cross-sectional area of the second clamping block is larger than a cross-sectional area of the first clamping block.

8. The floating board-to-board connector of claim 1, wherein a plurality of plug-in members and a plurality of pins are provided, and the plurality of pins are plugged into corresponding plug-in members in a one-to-one manner.

9. The floating board-to-board connector of claim 7, wherein the plug-in member comprises two plug-in elastic sheets, the plug-in elastic sheet comprises a plug-in part and a connecting part, one end of the connecting part extends out of the female header body for electrical connection with electrical components, another end of the connecting part is connected with the plug-in part, the plug-in part and the connecting part are obliquely arranged, and the two plug-in elastic sheets are oppositely arranged, so that the plug-in parts of the two plug-in elastic sheets are close to each other, and a gap between the two plug-in part forms the plug-in hole into which the pin is inserted.

10. The floating board-to-board connector of claim 9, wherein the plug-in part comprises a plug-in body and a flaring, the plug-in body is connected with the connecting part, the flaring inclines towards the connecting part, the flaring is smoothly connected with the plug-in body, and the flaring is used for avoiding the pin.
